(19) United States
(12) Patent Application Publication
(10) Pub. No.: US 2006/0037630 A1
(43) Pub. Date: Feb. 23, 2006

(54) Acoustic insulation blanket for dishwashers

(76) Inventors: Rowland Griffin, Pocono Summit, PA (US); John P. Field, Knowlton, NJ (US); Michael McCarthy, Salem, NH (US)

Correspondence Address: SHOEMAKER AND MATTARE, LTD, 10 POST OFFICE ROAD - SUITE 110, SILVER SPRING, MD, 20910, US

(21) Appl. No.: 11/196,616

(22) Filed: Aug. 3, 2005

Related U.S. Application Data
(60) Provisional application No. 60/598,060, filed on Aug. 3, 2004.

(51) Int. Cl. B08B 13/00

(52) U.S. Cl. 134/42; 134/201; 68/3 R

(57) ABSTRACT

An acoustic insulation blanket for a dishwasher has a head portion, a pair of wing portions, one on either side of the head portion, and a tail portion defined by V-shaped notches cut from the wing portions, the head portion being shaped to cover a top surface of the dishwasher, the tail portion being adapted to cover a portion of the rear surface of the dishwasher, and the wing portions being adapted to cover the right and left sides of the dishwasher and having wing tips adapted to be folded around the rear edges of the dishwasher and to be overlapped on the rear surface of the dishwasher.

### BACKGROUND OF THE INVENTION

This invention relates to an acoustic insulation blanket for dishwashers.

A piece or blanket of insulation is commonly placed inside the outer wall of a dishwasher, to muffle sounds emitted by the mechanism. One prior blanket is basically T-shaped, with the arms and leg of the “T” bent around the corners of the dishwasher so that it covers the sides, top and rear of the device. The rear side edges may not be completely covered, where the edges of the arms and leg meet.

### SUMMARY OF THE INVENTION

An object of the invention is provide an alternative insulation blanket which better covers the top and rear edges of a dishwasher.

These and other objects are attained by a acoustic insulation blanket for dishwashers as described below.

### BRIEF DESCRIPTION OF THE DRAWINGS

In the accompanying drawings,

FIG. 1 is a top plan view of an acoustic insulation blanket embodying the invention; and

FIG. 2 is a perspective view of the dishwasher, from the rear and above, showing how the blanket fully covers the rear side edges of the dishwasher in use.

### DESCRIPTION OF THE PREFERRED EMBODIMENT

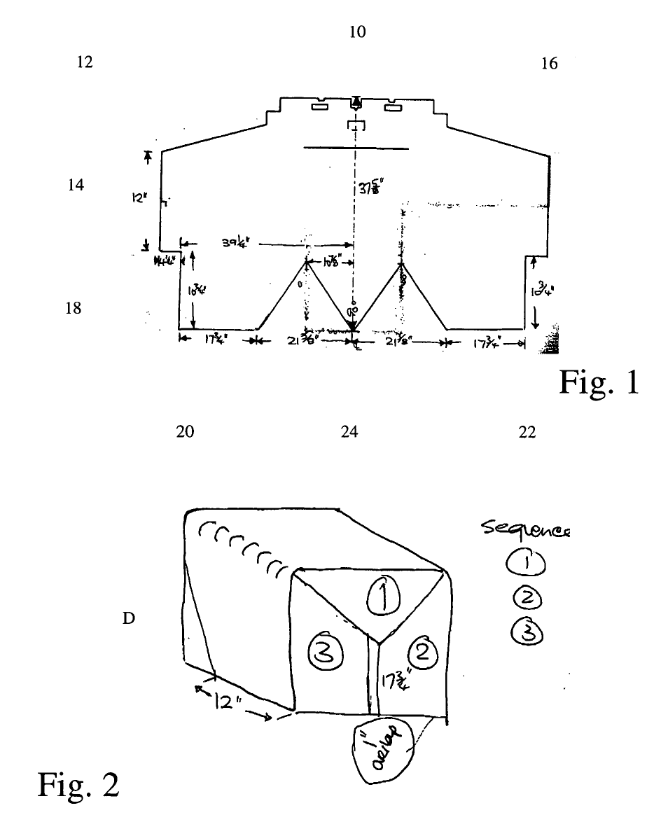

A dishwasher acoustic insulation blanket embodying the invention comprises a piece of insulation stock 10 cut as shown in FIG. 1. It comprises a head portion 12, two wing portions 14,16, and a tail portion 18 which is made up of two lateral tail sections 20,22 and a central tail section 24, created by cutting V-shaped pieces 26 from the tail. The total tail width is slightly less than the wing spread. The leading edges of the wings are swept back at an angle of about 15° from the head portion.

The rectangular apertures 28, 30 cut in the head serve to locate the blanket as it is wrapped around the dishwasher, the apertures being placed over tabs extending from the dishwasher.

In use, the blanket is wrapped around a dishwasher as shown in FIG. 2. The head portion is placed on the dishwasher “D” top near the door; the wings are folded down over the left and right sides of the dishwasher; the central tail portion is folded down over the back; the lateral tail portions are then folded toward one another, meeting at the center of the back and overlapping the central tail portion. The blanket is then suitable secured to the dishwasher body.

Inasmuch as the invention is subject to modifications and variations, it is intended that the foregoing description and the drawings shall be interpreted as merely illustrative of the invention defined by the following claims.

We claim:

1. An acoustic insulation blanket for a dishwasher, said blanket comprising
a head portion,
a pair of wing portions, one on either side of the head portion, and
a tail portion defined by V-shaped notches cut from said wing portions,
the head portion being shaped to cover a top surface of the dishwasher,
the tail portion being adapted to cover a portion of the rear surface of the dishwasher, and
the wing portions being adapted to cover the right and left sides of the dishwasher and having wing tips adapted to be folded around the rear edges of the dishwasher and to be overlapped on the rear surface of the dishwasher.

2. The acoustic insulating blanket for a dishwasher as claimed in claim 1, wherein the head portion has a plurality of apertures adapted to receive tabs extending from the dishwasher to hold the head portion in place during installation.

3. The of claim 1, wherein each wing portion has a leading edge which is swept backward at an angle of about 15°.

4. A method of covering a dishwasher with a single piece of insulation having a head portion, a pair of wing portions and a tail portion, said method comprising steps of
placing the head portion of the blanket on the top surface of the dishwasher so that the tail portion extends towards the rear of the dishwasher,
folding the tail portion down over the rear surface of the dishwasher, then
folding each wing portion down over the top edge of the dishwasher so as to cover the respective side of the dishwasher and then folding the tips of the wings and rear edges of the dishwasher and overlapping the rear wing tips and tail on the back surface of the dishwasher.
